(19) United States
(12) Patent Application Publication
(10) Pub. No.: US 2014/0072432 A1
(43) Pub. Date: Mar. 13, 2014

(54) BLADE ARRANGEMENT FOR A TURBO ENGINE

(71) Applicants: Marcus Woehler, Inning am Ammersee (DE); Harald Schoenenborn, Karsfeld (DE)

(72) Inventors: Marcus Woehler, Inning am Ammersee (DE); Harald Schoenenborn, Karsfeld (DE)

(73) Assignee: MTU Aero Engines GmbH, Muenchen (DE)

(21) Appl. No.: 14/008,743

(22) PCT Filed: Jun. 29, 2011
(86) PCT No.: PCT/EP2011/060891

§ 371 Date: Nov. 20, 2013

(30) Foreign Application Priority Data
Apr. 1, 2011 (EP) 11160764.4

(51) Int. Cl. F01D 5/10; B23P 15/04

(52) U.S. Cl. CPC F01D 5/10; B23P 15/04
USPC 416/175; 29/889.21

(57) ABSTRACT

A blade arrangement for a turbo engine, in particular a gas turbine, with a rotor and several blades fastened thereto, which are configured to be systematically different, wherein at least two adjacent blades have systematically different shrouds (12, 22) and/or inner blade platforms (11, 21).

The present invention relates to a blade arrangement for a turbo engine, in particular a gas turbine, a turbo engine with such a blade arrangement as well as a method for manufacturing such a blade arrangement.

### BACKGROUND

Because of their material elasticity, rotor blades have natural modes or eigenmodes. Modes are understood here in a conventional manner to mean natural frequencies and/or forms, in particular a first or higher bending or torsion natural form or frequency.

During operation, rotor blades are induced to vibrate, in particular because of unsteady interactions with the working fluid of the turbo engine. If such an excitation is in the proximity of a natural frequency, resonances or fluttering may occur, which affects the transformation of energy with the working fluid and strains the turbo engine, in particular its blades.

It is thus known from the generic U.S. Pat. Nos. 6,471,482 and 4,097,192, to mistune blades with one another i.e., arranging blades with different eigenmodes in such a way that an excitation always coincides only with the natural frequency of a portion of the blades. On the other hand, “mistuned” blades with other natural frequencies may advantageously reduce the resonance or fluttering. On this matter, the blade thickness varies in U.S. Pat. No. 6,471,482. In U.S. Pat. No. 4,097,192, empty recesses or recesses filled with impurities are configured in some blades in the blade head that faces away from the rotor. Both documents relate to blade arrangements that do not have shrouds since shrouds that make contact with each other are viewed as an alternative approach instead of the mistuning of individual blades.

### SUMMARY OF THE INVENTION

It is an object of the present invention provide a turbo engine, in particular a gas turbine, with an improved blade arrangement.

The present invention provides that in addition to or as an alternative to a mistuning by varying the blades, to vary the shrouds and/or inner blade platforms and thereby mistune the blades of a blade arrangement with one another. In general, two or more adjacent blades will have systematically different shrouds and/or inner blade platforms in this case. Systematically it is to be understood here in particular that differences are provided in a targeted manner. This may particularly be accomplished when blades, whose shrouds and/or inner platforms are scattered based on manufacturing tolerances, are assorted and then selected in a targeted manner. In a preferred embodiment, however, different blades are already manufactured systematically, i.e., blades that are different from one another from the beginning are manufactured for instance by appropriately predetermined variations in the manufacturing process, in particular by additional or omitted fabrication steps, particularly machining.

Blades with different shrouds and/or inner platforms, which are designated here as different blades, differ according to the first aspect in one or more eigenmodes, i.e., natural frequencies and/or forms. In this case, shrouds and/or inner blade platforms may in particular have different masses, mass distributions and/or moments of inertia. In a preferred further development in this case, a recess arrangement with one, two or more recesses is configured in a cover band and/or in an inner platform of a blade, while no recess arrangement or another recess arrangement having a different number and/or geometry of recesses is configured in a cover band or in an inner platform of at least one other, in particular adjacent, blade. Recesses may be configured to be closed or open, in particular as passage openings. In a preferred further development, they function additionally as a conduit for a fluid, in particular a cooling fluid. In general, recesses may be empty, fluid may flow through them or they may even be filled completely or partially with a material other than the blade material, in particular a lighter or heavier material.

As an addition or alternative, shrouds and/or inner blade platforms may have different levels of stiffness, in particular bending and/or torsional stiffness. Such different levels of stiffness may also be represented in particular by recesses or material accumulations.

Shrouds of adjacent blades preferably contact one another, which are understood here in particular as radially outward, fluid-conducting surfaces, i.e., defining a flow channel, which preferably extend at least substantially in the circumferential direction. Shrouds may be connected detachably or non-detachably with flow-diverting blades extending essentially in the radial direction and/or with adjacent shrouds, in particular be configured integrally. Additionally or alternatively, inner blade platforms of adjacent blades preferably contact one another, which are understood here in particular as radially inward fluid-conducting surfaces, i.e., defining a flow channel. Inner blade platforms may be connected detachably or non-detachably with blades pans and/or with adjacent inner blade platforms, and will in particular be configured integrally.

In a preferred embodiment, different shrouds and/or inner blade platforms may have different geometries, especially fluid-conducting geometries, contact geometries and/or fluid-averted geometries. For one, this makes it possible to represent the aforementioned different masses (or mass distributions) or moments of inertia and/or levels of stiffness as for instance adjacent shrouds have different wall thickness, forms or the like. As an addition or alternative to such inertial properties, according to a further aspect of the present invention, a locally different excitation may also be hereby represented: thus, because of different, mutually contacting contours of adjacent shrouds and/or inner blade platforms, which are designated here as contact geometries, the transmission of vibrations or coupling between adjacent blades may be varied. Additionally or alternatively, by varying the surface of the shrouds and/or inner blade platforms, which are facing the working fluid of the turbo engine or are in contact therewith, the fluid-induced excitation on the individual blades may be varied. In a preferred further development, particularly the two-dimensional or three-dimensional flow path contour differs at the transition between the blade and cover band and/or the inner blade platform between adjacent blades.

In addition to the systematically different embodiment of shrouds and/or inner blade platforms according to the invention, two or more blades of the blade arrangement may have systematically different blades. Different blades may differ corresponding in particular with respect to their masses, mass distributions, moments of inertia and/or contours, in particular camber lines, profiles, profile thicknesses, cants or sweeps or the like.

Gamma titanium aluminides (γ-TiAl) represent an advantageous material particularly for high-speed turbo engines. However, they are disadvantageous because they demonstrate a worse creep behavior than conventional high-speed materials, such as those that are nickel-based. Correspondingly, a mistuning of the rotor blades with one another according to the invention is advantageous particularly in the case of blade arrangements whose blades generally have an intermetallic compound, in particular with titanium and/or aluminum, preferably γ-TiAl. Such blades may be made at least substantially of the compound, in particular γ-TiAl, or feature a coating thereof.

According to the invention, shrouds and/or inner blade platforms may be systematically different. In this case, the arrangement of different rotor blades on the circumference of the rotor may itself be stochastic. For example, an assortment of different rotor blades may be distributed randomly over the circumference. In a preferred further development, however, different blades are for their part distributed systematically over the circumference of the rotor. In this case it is to be especially understood that a specific location or area on the circumference of the rotor is predetermined for specific blades or one or more blade(s) with specific properties, e.g., a specific weight, are predetermined for a specific location or area. In particular, the different blades may, in a preferred further development, be distributed hereby in such a way that differences, in particular mass differences or mass distribution differences, may, at least substantially, compensate for one another. In particular, a mass distribution of the blade arrangement as a whole may thus be balanced over the circumference. Purely exemplarily, blades or groups of two or more blades may be distributed in an alternating manner over the circumference, which have one or no empty recess in their cover band and/or their inner platform such that the weight differences over the circumference are, at least substantially, compensated for.

A blade arrangement according to the invention is especially advantageous in high-speed turbo engines, particularly gas turbines such as aircraft engines, and in those especially in low-pressure turbines. A blade arrangement according to the invention may extend in general in the circumferential and/or axial direction and thus form in particular one or more stages of a turbo engine. Correspondingly, different blades may be adjacent to each other in the circumferential and/or axial direction.

Additional advantages and features are disclosed in the subclaims and the exemplary embodiment. The drawings show the following partially schematically:

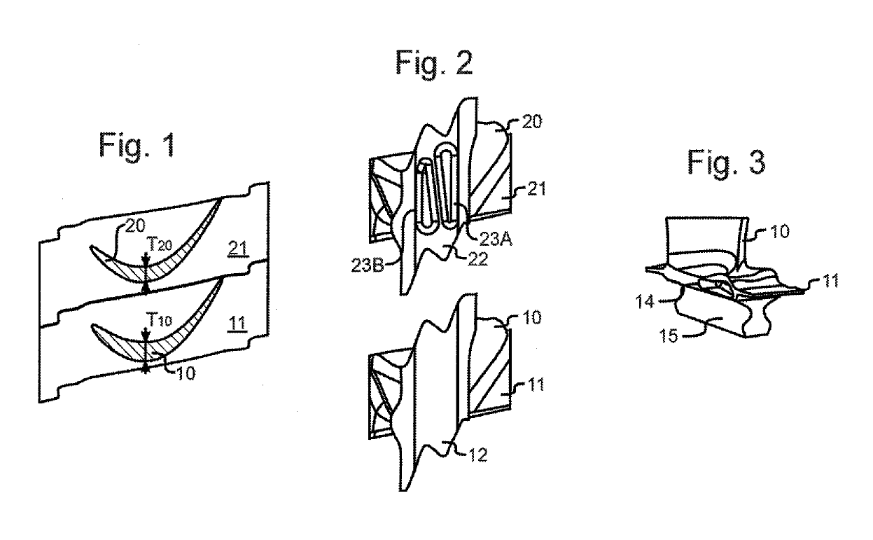

a. FIG. 1: A section through two adjacent rotor blades;

b. FIG. 2: The two adjacent rotor blades of FIG. 1 from the radial outside; and

c. FIG. 3: A perspective partial section of one of the rotor blades from FIGS. 1 and 2.

FIG. 1 shows from the radial outside a section through two rotor blades of a turbine stage that are adjacent in the circumferential direction (vertically in FIG. 1). The section shows the blades 10, 20 as well as the contacting inner blade platforms 11, 21. The section shows that the two adjacent rotor blades have different blades, in particular different profile sizes or thicknesses T₁₀, T₂₀.

Depicted for clarification in an exploded manner in the circumferential direction, FIG. 2 shows the two blades from FIG. 1, again from the radial outside, but not in section. One can again see the blades 10, 20 (not in section in FIG. 2), as well as the inner blade platforms 11, 21, which are not in contact due to the exploded representation in FIG. 2. In addition, FIG. 2 shows the radially outward surfaces of the shrouds 12, 22 facing away from the working fluid or flow channel, which is defined by the facing surfaces of the inner blade platforms and shrouds. Like the inner blade platforms 11, 21, the shrouds 12, 22 of the adjacent blades in the circumferential direction are also in contact with one another in an assembled state and are depicted in FIG. 2 in an exploded manner in the circumference direction only for purposes of clarification.

According to the invention, the shrouds 12, 22 are equipped differently: whereas the cover band 12 essentially is a solid material and has a smooth, radially outward surface (which is shown in FIG. 2), a recess arrangement with two annular-channel-like recesses 23A, 23B is configured in the corresponding surface of the cover band 22. The cover band 22 hereby has, as compared to the cover band 12, a different mass, mass distribution and a different moment of inertia in particular around a bending axis and a torsion axis of the blades 10, 20, so that the eigenmodes of the two blades are also mistuned with each other.

FIG. 3 shows a perspective partial section of the lower rotor blade from FIGS. 1 and 2. One can see a portion of the blade 10 as well as the inner blade platform 11 and the blade footing 15. In contrast to the inner platform 21 of the adjacent blade (not shown) that is configured as a solid material, a recess 14 is configured in this so that the inner blade platforms 11, 21 also have different masses, mass distributions and levels of stiffness, so that the eigenmodes of the two blades are also thereby mistuned with each other.

In addition, the fluid-conducting geometry at the transition between the blade 10 and the blade footing 11 is different from the geometry of the adjacent blade (not shown) so that the excitation on the two adjacent blades hereby varies.

1-8. (canceled)

9. A blade arrangement for a turbo engine having a rotor and several blades fastened thereto, comprising:
at least two adjacent blades have systematically different shrouds and/or inner blade platforms.

10. The blade arrangement as recited in claim 9 wherein the different shrouds and/or inner blade platforms have different geometries, different masses, mass distributions, moments of inertia and/or levels of stiffness.

11. The blade arrangement as recited in claim 10 wherein the different shrouds and/or inner blade platforms have different fluid-conducting geometries, contact geometries and/or fluid-averted geometries.

12. The blade arrangement as recited in claim 10 wherein a recess arrangement with at least one recess is configured in a shroud and/or in an inner platform of a first blade, and no recess arrangement or another recess arrangement having a different number and/or geometry of recesses is configured in a shroud or in an inner platform of an adjacent blade.

13. The blade arrangement as recited in claim 9 wherein the blades have an intermetallic compound.

14. The blade arrangement as recited in claim 13 wherein the intermetallic compound includes titanium and/or aluminum.

15. The blade arrangement as recited in claim 14 wherein the intermetallic compound includes γ-TiAl.

16. The blade arrangement as recited in claim 9 wherein the at least two adjacent blades or other adjacent blades have systematically different blades.

17. The blade arrangement as recited in claim 9 wherein different blades are distributed systematically over the circumference of the rotor in such a way that differences compensate for one another at least substantially.

18. The blade arrangement as recited in claim 17 wherein the differences are mass differences or mass distribution differences.

19. A turbo engine comprising the blade arrangement as recited in claim 9.

20. A gas turbine comprising the blade arrangement as recited in claim 9.

21. A method for manufacturing a blade arrangement as recited in claim 9 comprising manufacturing different blades in an assorted and/or systematic manner.
